(19) United States
(12) Patent Application Publication
(10) Pub. No.: US 2008/0018753 A1
(43) Pub. Date: Jan. 24, 2008

(54) Method for modifying images by a way of capturing raw image data

(76) Inventor: Chun-Ta Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/488,760

(22) Filed: Jul. 19, 2006

(51) Int. Cl. H04N 5/76

(52) U.S. Cl. 348/231.99

(57) ABSTRACT

A method for modifying images by a way of capturing raw image data, includes: capturing raw image data; storing the raw image data in a storage unit; reading the raw image from the storage unit; modifying the image's size and parameters for the raw image data via an image processing unit; and transforming the modified raw image data into an image file with a predetermined format. Thereby, users can obtain a desired compressed image file.

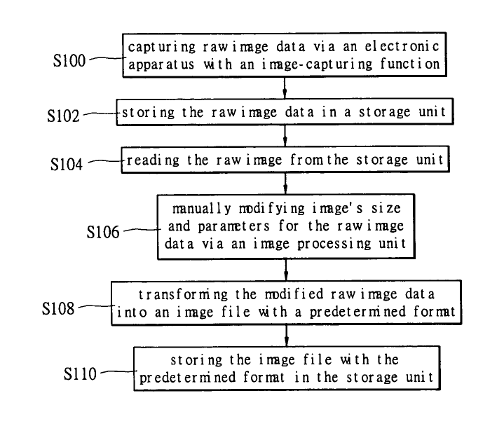

### BACKGROUND OF THE INVENTION

1. Field of the Invention

The present invention relates to a method for modifying images by a way of capturing raw image data, and particularly relates to a method of modifying image size and image parameters for raw image data. Hence, a user can obtain a desired compressed image file easily.

2. Description of the Related Art

There are many methods for people to commemorate an occasion. One common way is by taking pictures, because any occasion such as travel, a celebration, an event or any good time that deserves to be commemorated can be recorded via a camera. Moreover, it is convenient for users to transmit image data from the camera to an electronic device such as a computer for modifying the image data. In addition, the price of a camera has become increasingly cheaper, so the number of people using digital cameras increases day by day.

In different environments, such as nighttime or the middle of the day, the user needs to adjust the camera's image-shooting parameters, such as brightness or film speed, in order to obtain a good quality picture. However, most users are not professionals. Hence, the image-shooting parameters are often incorrectly adjusted and users cannot obtain the picture they wanted. Moreover, although the image can be modified later via image-modifying software, the quality of the picture cannot be improved and the quality of the picture worsens after modifying. In addition, it's a pity if the user misses the photo opportunity, and the user cannot return to capture the same image.

### SUMMARY OF THE INVENTION

The present invention provides a method for modifying images by a way of capturing raw image data. The method uses an electronic apparatus with an image-capturing function for capturing raw image data, and then uses an image processing unit that is stored in the electronic apparatus for modifying the image's size and parameters for the raw image data. Hence, a user can obtain the desired compressed image file.

A first aspect of the present invention is a method for modifying images by a way of capturing raw image data, comprising: capturing raw image data; storing the raw image data in a storage unit; reading the raw image from the storage unit; modifying the image's size and parameters for the raw image data via an image processing unit; and transforming the modified raw image data into an image file with a predetermined format.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The FIGURE is a flow chart of a method for modifying images by a way of capturing raw image data according to the present invention.

### DETAILED DESCRIPTION OF PREFERRED BEST MOLDS

Referring to the FIGURE, the present invention provides a method for modifying images by a way of capturing raw image data, comprising: firstly, capturing raw image data via an electronic apparatus with an image-capturing function (S100). The electronic apparatus can be a digital camera, a cell phone, or a PDA. Next, the method comprises: storing the raw image data in a storage unit (S102). The storage unit can be an external memory or a built-in memory.

Moreover, the method further comprises: reading the raw image from the storage unit (S104), and then manually modifying the image's size and parameters for the raw image data via an image processing unit (S106). In addition, the image processing unit is built inside the electronic apparatus, and the image's parameters comprise hue, brightness, contrast and sharpness, or can be any relevant image modifying and adjusting parameters.

Furthermore, the method further comprises: transforming the modified raw image data into an image file with a predetermined format (S108). In addition, the image file with the predetermined format can be a compressed color image such as a JPEG (Joint Photographic Experts Group) file. Finally, the method comprises: storing the image file with the predetermined format in the storage unit (S110).

In conclusion, the method uses an electronic apparatus with an image-capturing function for capturing raw image data, and then uses a image processing unit that is stored in the electronic apparatus for modifying the image's size and parameters for the raw image data. Hence, a user can obtain a desired compressed image file.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for modifying images by a way of capturing raw image data, comprising:
capturing raw image data;
storing the raw image data in a storage unit;
reading the raw image from the storage unit;
modifying the image's size and parameters for the raw image data via an image processing unit; and
transforming the modified raw image data into an image file with a predetermined format.

2. The method as claimed in claim 1, wherein the step of capturing the raw image data further comprising: using an electronic apparatus with an image-capturing function to capture the raw image data.

3. The method as claimed in claim 2, wherein the electronic apparatus is a digital camera, a cell phone, or a PDA.

4. The method as claimed in claim 2, wherein the image processing unit is built inside the electronic apparatus.

5. The method as claimed in claim 1, wherein the storage unit is an external memory or a built-in memory.

6. The method as claimed in claim 1, wherein the image parameters comprises hue, brightness, contrast and sharpness.

7. The method as claimed in claim 1, wherein the image file with the predetermined format is a compressed color image.

8. The method as claimed in claim 1, further comprising: storing the image file with the predetermined format in the storage unit.
